(19) United States
(12) Patent Application Publication
(10) Pub. No.: US 2005/0166652 A1
(43) Pub. Date: Aug. 4, 2005

(54) Urea based fertilizer, fungicide and insecticide

(76) Inventor: David H. Blount, San Diego, CA (US)

Correspondence Address: David H. Blount, 6728 Del Cerro Blvd., San Diego, CA, 92120, US

(21) Appl. No.: 11/010,654

(22) Filed: Dec. 13, 2004

Related U.S. Application Data
(63) Continuation-in-part of application No. 10/859,716, filed on Jun. 3, 2004.
Application No. 10/859,716 is a continuation-in-part of application No. 09/973,553, filed on Oct. 9, 2001, now Pat. No. 6,777,469.
Application No. 09/973,553 is a continuation-in-part of application No. 09/693,194, filed on Oct. 23, 2000, now Pat. No. 6,464,903.
Application No. 09/693,194 is a continuation-in-part of application No. 09/149,847, filed on Sep. 8, 1998, now Pat. No. 6,258,298.
Application No. 09/149,847 is a continuation-in-part of application No. 08/723,779, filed on Sep. 30, 1996, now Pat. No. 5,854,309.

(51) Int. Cl. C05F 1/00

(52) U.S. Cl. 71/11

(57) ABSTRACT

Fertilizer, fungicide and insecticide compositions are produced by the process of this invention. The potassium urea salts of phosphorus, boron or sulfur containing compounds are produced by reacting urea with and acidic mineral acid compound then reacting this urea salt of mineral acid with a basic salt forming compound such as potassium hydroxide. These fertilizer, fungicide and insecticide compositions may be applied by spraying on plants in a dilute aqueous solution to give plants some protection against dry rot, fungi and insects and also fertilizer the plant. It also acts as an insecticide against insect such as termites, cockroaches and ants.

This application is a continuation in part of application Ser. No. 10/859,716 filed Jun. 3, 2004 which is a continuation-in-part application Ser. No. 09/973,553, filed on Oct. 9, 2001 now U.S. Pat. No. 6,777,469, which is a continuation-in-part of application Ser. No. 09/693,194, filed 10/23/200, now U.S. Pat. No. 6,464,903 B1, which is a continuation-in-part of patent application Ser. No. 09/149/847 filed Sep. 8, 1998 now U.S. Pat. No. 6,258,298 which is a continuation-in-part of patent application Ser. No. 08/723,779 filed Aug. 30, 1996, now U.S. Pat. No. 5,854,309.

### FIELD

The invention concerns urea and it's salts. The invention also concerns their preparation and use. The urea based compounds are useful to produce insecticide, fungicide and rapid acting and long acting fertilizer products, and may be reacted with potassium and/or phosphorus to produce other fertilizer, fungicide and insecticide compounds.

### BACKGROUND

The heating of urea to produce urea condensation compounds, such as biuret and a mixture of cyanuric acid and cyamelide, is known in the arts, but the urea based compounds utilized to produce improved short acting and long acting fertilizer, fungicides and insecticide compounds is novel. U.S. Pat. No. 5,788,915 utilizes partially hydrolyzed condensated urea as a flame retardant. The urea based compounds and their phosphorus and/or sulfate salts and/or may be used as a fungicide, insecticide and a rapid acting and long acting fertilizer compounds.

What is lacking and what is needed are useful inexpensive urea based fertilizer, fungicide and insecticide with a plurality of nitrogen moieties. The urea based compounds and/or their salts of this invention are novel fungicides, insecticide and rapid acting and long acting fertilizer compounds. What is additionally lacking are compositions having such urea based compounds and/or their salts employed therein. The urea and a salt forming compound is heated at a low enough temperature to avoid urea reacting with itself to produce biuret or other condensates.

### SUMMARY

In one aspect, the invention comprises urea based salts. Another aspect of the invention is a process to prepare urea based salts comprising serially contacting, heating and reacting:
(A) urea;
(B) acidic salt forming compound
(C) basic salt forming compound
   then add;
(D) filler
(E) water
   under conditions sufficient to prepare the urea based salts. A urea based salt is produced by reacting an acidic salt forming compound to form an acidic urea salt and then a basic salt forming compound is reacted with the urea or its acidic salt. It is preferable to react the urea with the acidic salt forming compound first then add and react the basic salt forming compound. A filler may be added to the urea based salt to produce a composition. The pH of the urea salts maybe adjusted to have a pH of 1.5-8.5 by utilizing an acidic salt forming compound or a basic salt forming compound or buffering compound such as organic acid. Water is added to the urea based salt to form an aqueous solution which is diluted to the desired urea based salt concentration. The nitrogen, phosphorus, potassium and boron content may be quite varied in the urea based salts.

In another aspect, the invention comprises urea salt of phosphorus and/or sulfate and/or boron containing compound and a process to prepare a urea salt of a phosphorus and/or sulfate and or boron containing compound employing phosphorus and/or sulfur and/or boron containing compound that will react with the urea compound under conditions sufficient to prepare the urea salt of a phosphorus and/or sulfur and/or boron containing compound, and a process to prepare a urea salts of a phosphorus and/or a sulfur and/or a boron containing compound that is reacted with a basic salt forming compound comprising serially contacting, heating and reacting:
(A) urea;
(B) acidic salt forming compound that will react with urea
(C) basic salt forming compound
   then add:
(D) filler
(E) water
   component A and B are first mixed then heated up to 120 degree C. for 0.1 to 3 hours at ambient pressure, then component C is added and reacted at ambient pressure, heated up to 120 degrees C. for 0.1 to 3 hours, then component D is added and mixed. The urea salts are usually diluted with water in the ratio of 1:40 to 1:600 and pH is adjusted to be acceptable for foliage uptake of phosphorus.

An additional aspect of the invention is the use of the urea based compounds, urea based salts of phosphorus and/or sulfur and/or boron compounds reacted with a basic salt forming compound utilized as an insecticide, fungicide and a rapid acting and long acting fertilizer compounds. The fertilizer, fungicide and insecticide compositions may consist of urea salt of a phosphorus and/or sulfur and/or boron containing compound and basic salt forming compounds and fillers.

The fungicide, insecticide and fertilizer compounds of this invention are produced by reacting urea with an acidic salt forming compound, preferably a phosphorus oxyacid compound with a valence of 3 or a combination of a phosphorus oxyacid with a valence of 3-4 and one with a valence of 5. In order to increase resistant of plants to aphids and fungus addition compounds are added and reacted with the urea salt such as, potassium or potassium salts, The urea salts are useful as fungicides and insecticide but may be enhance by reacting boron oxyacid or their salts with the urea salts and utilized as a fungicide and an insecticide especially for use to kill ants termites and cockroaches.

Fertilizer maybe added to the plants foliage in a dilute aqueous form or may be added to the soil of crops in the form of a concentrated aqueous solution or as granules. Many elements are essentially to the health and growth of plants. Nitrogen, phosphorus and potassium are provided in the greatest quantity. The phosphorus may be in any suitable form and contain 3-5 valences. Phosphorus with 34 valences or a combination of phosphorus with 3-4 valences and phosphorus with 5 valences reacted with urea and potassium may be used in a dilute aqueous solution to spray on plant foliage and is helpful to the plant to resist aphides, fungus, dryrot, fungus, pest, etc. The urea salts may be produced in a concentrated form which stays in solution and is essentially clear which can be diluted with water and applied on plant foliage or to the plants soil. The phosphorus with a valence of 34 is less likely to support the growth of algae.

### Component A

Urea and or methyl urea are utilized as component A and may be in the form of a powder, crystals or a solid. Any suitable urea may be utilized Urea is utilized in the amount of 25-100 parts by weight.

### Component B

Any suitable acidic salt forming compound may be utilized in this invention. Suitable salt forming compound are organic and inorganic phosphorus acids, boron oxyacids or sulfuric acids and their acidic salts. These acidic components are compounds such, for example, acids or salts, or their derivatives of sulfur, boron and phosphorus, such as, phosphorus oxyacids, boron oxyacids, sulfur oxyacids, boron-phosphates, phosphates, phosphorous acid, hypophosphorous acid, polyphosphorous acid, polyhypophosphorus acid, ammonium salts of phosphorous acids, polyphosphates of ammonia, alkali metal hydrogen phosphates, alkaline earth metal hydrogen phosphates, acidic phosphates of amines, polyamines, amino compounds, thioureas and alkyanolamines, boric acid and its salts and their derivatives, organic phosphorus compounds and their salts, halogenated organic phosphorus compounds, their salts and their derivatives, or organic acids having the formula R-COOH where R is hydrogen or a carbon containing molecule or group of molecules may also be used for this purpose of adjusting the pH. The preferred organic acids are dicarboxylic and tricarboxylic acids. The acidic salt forming compounds may be used in quantities of 25 to 400 parts by weight.

The urea and potassium containing salts of phosphorus acids are the preferred salts for use as a fertilizer. The urea containing salts of boron-phosphate is the preferred salts for use as an insecticide and as a fungicide. The basic urea salt of phosphorus compounds are produced by contacting the urea compounds with a phosphorus oxyacid compound that will react with urea compound, under conditions sufficient to prepare an acidic urea based salt of a phosphorus oxyacid. Suitable inorganic phosphorus compounds include, but not limited to, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids. organic phosphorus compounds include, but not limited to, alkyl, cyclic, aryl and alkyl-aryl phosphorus compounds, such as, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters and mixtures thereof. Urea borates may be produced by contacting boric acid and partially hydrolyzed urea condensate compound under conditions sufficient to prepare the urea borates. Urea salt of boron-phosphates may be produced by contacting boron-phosphates and urea under conditions sufficient to prepare urea salt of boron-phosphate compounds. The salt forming phosphorus containing compounds will react with the urea to form a urea salt of a phosphorus containing compound. The phosphorus containing compounds are the preferred acidic salt forming compounds. The acidic salt form compound may be in the form of a solid. liquid or an aqueous solution.

### Component C

Any suitable basic salt forming compounds may be utilized in this invention. The potassium basic salt forming compounds are preferred. Suitable basic salt forming compounds include but not limited to alkali metal containing compounds, alkaline earth metal containing compounds, ammonia, amines, polyamines, alkyl alcohol amines, amino compounds and mixtures thereof. The basic salt forming compound may react with the urea salts. Mixtures of the acidic and basic salt forming compounds may be utilized. The basic salt forming compounds are utilized in the amount of 25 to 300 parts by weight. The basic salt forming compounds may be in the form of a solid, liquid or an aqueous solution.

### Component D

Any suitable filler or bait may be used in this invention. The fillers may be inorganic substances, such as, alkali metal compounds, lime, alkaline earth metal silicates, metal silicates, silica, metals, oxides, carbonates, sulfates, phosphates, borates, sulfur and organic matter such as cellulose materials. They may be organic substances, such as, amino compounds, such as urea, methyl urea, melamine, dicyandiamide, aminophosphates, amino salts of organic phosphates, and mixtures thereof. The fillers may also be substances that act as bait for insects such as carbohydrates, such as sugar, syrups, corn meal flour, etc., vegetable and fatty oils, and cellulose materials. Fillers may be added in the amount of 0 to 300 parts by weight. When the filler is added it may be added in the amount of 1 to 300 parts-by weight. Suitable organic nitrogen containing compounds may be an aliphatic, aromatic, cyclic, aliphatic-aromatic or aliphatic-cyclic compound such as, but not limited to, urea, urea derivatives for example, O-alkylureas, amino compounds, for example, melamine, melamine cyanurate, dicyandiamide, biuret, cyanuric acid, cyamelide, guanidine, cyanoguanidine, ammeline and aminoguanidine, guanidine carbonate, ammonium carbonate, alkyl carbamates, alkyl isocyanates, polyisocyanates, sulfamic acid, ammonium sulfamate, amines, polyamines, thioureas, alkylanolamine, polyamides, amino hydrogen phosphates, amidines, amides, aldimines, ketimines, amino carbonates, aminoborates, amino sulfates, thiourea derivatives, alkylanolamines, nitrites, etc., and mixtures thereof. Suitable inorganic nitrogen containing compounds such as, but not limited to, ammonium phosphate, diammonium phosphate, ammonium polyphosphate, ammonium borate, sodium borate, calcium borate, zinc borate, ammonium hydrogen sulfate, quaternary ammonium salts, ammonium bicarbonate, ammonium carbonate, ammonium carbamate etc. and mixtures thereof. The amino compounds are the preferred nitrogen containing compound. The filler may be utilized in the amount of 0-300 parts by weight. When they are utilized they are used in the amount of 1-300 parts by weight. The filler may be in the form of a powder, liquid or aqueous solution.

### Component E

Water is utilized to dilute the urea based composition to any desirable dilution.

### Illustrative Embodiments

In general, the urea based compounds are compounds which are produced by heating urea with an acidic salt forming compound that will react with urea then the salt is reacted with a basic salt forming compound.

The urea is reacted with an acidic salt forming compound by mixing and/or heating this mixture to up to 120 degree C. for 0.1 to 3 hours at ambient pressure. A basic salt forming compound is added to and reacted with the acidic urea salt. The basic salt forming compound will usually react with the urea also. The mineral acids will react with the urea without heating but may be further reacted by heating thereby producing an acidic salt which is further reacted with a basic salt forming compound. The urea salts may be produced in form of a liquid or a solid which is cooled then ground into a powder or added to water to form an aqueous solution. A combination of the acidic and basic salt forming compounds may be utilized to adjust the pH preferably in the range of pH 5-8.5. The reaction of the components may take place at ambient pressure or at an elevated pressure usually ambient pressure is preferred. Fillers may be added to this compound while it is melted or to the powder form or added to the aqueous solution to form a urea composition or may be produced as a liquid and fillers are added to this liquid.

### DESCRIPTION OF PREFERRED EXAMPLES

The present invention will now be explained herein-after by way of a few examples and comparative examples, these examples setting, however, no limits to this invention. Parts and percentages are by weight, unless otherwise indicated.

### Example 1

10 parts by weight of urea is added to 50 parts by weight of phosphorous acid, mixed then heated to 75 degree C. until the components melt and reacted to produce an acidic urea salt of phosphorous acid then the remaining phosphorous acid and acidic urea salt of phosphorous acid is reacted at ambient temperature and pressure with a 50% aqueous solution of potassium hydroxide until the pH 6.5 is obtained thereby producing a potassium urea salt of phosphorous acid.

### Example 2

Example 1 is modified wherein 10 parts by weight of potassium phosphate is added with the urea.

### Example 3

About 20 parts by weight of urea beads are added to 50 parts by weight of phosphorous acid and 10 parts by weight of phosphoric acid at ambient pressure then heated to 105 degrees C. for 20 minutes, then a 50% aqueous solution of potassium hydroxide is slowly added at ambient temperature until the pH is 6 thereby producing a concentrated liquid fertilizer, fungicide and insecticide compound.

### Example 4

About 100 parts by weight of urea, is mixed with 30 parts by weight of potassium phosphate, 80 parts by weight of phosphoric acid and 50 parts by weight of ammonium phosphite at ambient pressure then heated to 100 degree C. for 20 minutes. Aqueous ammonium hydroxide is slowly added while agitating until the pH is 6.5, thereby producing a concentrated liquid fertilizer, fungicide and insecticide compound.

### Example 5

Example 4 is modified wherein ammonia is utilized in place of aqueous ammonium hydroxide and 10 parts of ammonium nitrate is added as a filler.

### Example 6

Example 4 is modified wherein orthophosphoric acid is utilized in place of phosphoric acid and 10 parts by weight of tetrapotassium phosphate added as a filler.

### Example 7

20 parts by weight of urea is mixed at ambient pressure with 40 parts by weight of hypophosphorous acid and 10 parts by weight of phosphoric acid then heated to 105 degree C. for 15 minutes then 50% aqueous potassium hydroxide is slowly added and reacted until the pH 5.5 is obtained then 3 parts by weight of zinc borate is added thereby producing a concentrated liquid fertilizer, fungicide and insecticide.

### Example 8

Example 7 is modified wherein another salt forming compound is used in place of hypophosphorous acid and selected from the list below thereby producing an acidic urea based salt of the salt forming compound listed below:

| | | | |
|---|---|---|---|
| a) | phosphorus acid | b) | sulfuric acid |
| c) | boric acid | d) | dimethyl methyl phosphonate |
| e) | polyphosphoric acid | f) | pyrophosphoric acid |
| g) | hypophosphoric acid | h) | phosphinous acid |
| i) | phosphinic acid | j) | phosphine oxide |
| k) | potassium hydrogen phosphate | l) | ammonium hydrogen |
| | | | phosphate |
| m) | potassium salt of hydrogen | n) | urea hydrogen phosphate |
| | phosphorous acid | | |
| o) | polyphosphorous acid | p) | polyhydrophosphorous acid |
| q) | mixtures of the above. | r) | phosphorous acid + |
| | | | citrate acid |

### Example 9

About 10 parts by weight of urea and 5 parts by weight of methyl urea are mixed with 35 parts by weight of polyphosphorous acid, then heated to above the melting point of the urea compounds for about 30 minutes at ambient pressure, thereby producing acidic urea based salt of phosphorous acid then an aqueous solution containing 50% potassium hydroxide is slowly added until the solution has a pH of 6.5 thereby producing a fertilizer, fungicide and insecticide compound.

### Example 10

5 parts by weight of boric acid is heated and reacted with the 25 parts by weight of phosphoric acid thereby producing a boron-phosphoric acid then 5 parts by weight of urea is added and heated to 100 degree C. for 20 minutes then a 50% aqueous potassium hydroxide is slowly added and reacted until the pH 7 is obtained thereby producing a fertilizer, fungicide and insecticide compound.

### Example 11

Example 9 is modified wherein another phosphorus containing compound is utilized in place of phosphoric acid and selected from the list below:

a) pyrophosphoric acid
b) phosphinic acid
c) phosphorus trichloride
d) phosphorus oxytrichloride
e) phosphorus oxide
f) ammonium dihydrogen phosphate
g) mono-aluminum phosphate
h) dimethyl methyl phosphonate (DMMP)
i) dimethyl hydrogen phosphite
j) phenyl acid phosphate
k) methylchlorophosphine
l) phosphorus tribromide
m) phosphorus thiochloride
n) tris(2-chloropropyl) phosphate
o) triphenyl phosphite
p) tris 2-chloroethyl phosphite
q) triethyl phosphite
r) urea dihydrogen phosphate
s) diethyl phosphite
t) trimethyl phosphite
u) dibutyl pyrophosphoric acid
v) melamine hydrogen boron-phosphate
x) hypophosphorous acid
y) methyl amine salt of phosphoric acid
z) O,O-dimethyl hydrogen dithiophosphate

### Example 12

Example 3 is modified wherein 5 parts by weight of ammonium sulfate is added as a filler.

### Example 13

Example 7 is modified wherein 20 parts by weight of powdered dimelamine phosphate is added to and mixed in with the urea thereby producing a fungicide, insecticide and fertilizer composition which is cooled and ground into a powder.

### Example 14

25 parts by weight of melamine hydrogen phosphate powder is added to and mixed in with the 20 parts by weight of urea then mixed with 60 parts by weight of phosphorous acid then heated to 110 degree C. for 15 minutes and then a 50% aqueous potassium hydroxide is slowly added and reacted until a pH 6.5 is reached thereby producing a fertilizer, fungicide and insecticide compound.

### Example 15

20 parts by weight of urea and 100 parts by weight of phosphorous acid flakes are slowly added then heated to about 100 degree C. for 15 minutes at ambient pressure thereby producing an acidic urea salt of phosphorous acid. The acidic urea salt of phosphorous acid is reacted with a 50% aqueous potassium hydroxide solution by slowly adding the aqueous potassium hydroxide solution to the urea salt of phosphorous acid until a pH 6.5 is obtained thereby producing a fertilizer, fungicide and insecticide compound.

### Example 16

Example 15 was modified wherein aqueous ammonia or anhydrous ammonia was utilized instead of the potassium hydroxide thereby producing a fertilizer, fungicide and insecticide compound.

### Example 17

10 parts by weight of urea and 30 parts by weight of melamine hydrogen phosphate and 5 parts by weight of urea borate are mixed then heated above the melting point of urea and up to 120 degree C. for 20 minutes at ambient pressure then potassium hydroxide is in a sufficient amount to where the pH is 6, thereby producing a fertilizer, fungicide and insecticide composition. After cooling it is ground into a powder.

### Example 18

Example 1 is modified wherein 20 parts by weight of a phosphorus salt forming compound selected from the list below is added to in place of phosphorous acid and reacted with the urea;

a) phosphoric acid
b) pyrophosphoric acid
c) dimethyl methyl phosphonate (DMMP)
d) dimethyl hydrogen phosphite
e) trimethyl phosphite
f) phenyl acid phosphate
g) phosphorus trichloride
h) phosphinic acid
i) phosphorus oxytrichloride
j) ammonium dihydrogen phosphate
k) dimethyl phosphoric acid
l) diethyl ethyl phosphonate
m) magnesium hydrogen phosphate
n) mono aluminum phosphate

### Example 19

Example 1 is modified wherein 5 parts by weight of a powdered filler selected from the list below is mixed with potassium urea salt of phosphorous acid:

| | | | |
|---|---|---|---|
| a) | hydrated aluminum | o) | urea phosphate |
| | oxide powder | | |
| b) | hydrated sodium silicate powder | p) | silica powder |
| c) | melamine | q) | phenol-formaldehyde |
| | | | resin powder |
| d) | dicyandiamide | r) | aluminum phosphate |
| e) | urea | s) | thiourea |
| f) | melamine phosphate | t) | diatomaceous earth |
| g) | melamine borate | u) | expandable graphite |
| h) | ammonium phosphate | v) | melamine salt of DMMP |
| i) | ammonium pyrophosphate | r) | ammonium sulfate |
| j) | ammonium carbonate | s) | magnesium chloride |
| k) | ammonium borate | t) | antimony trioxide |
| l) | ammonium sulfamate | u) | boron-phosphate powder |
| m) | guanidine | w) | melamine boron-phosphate |
| | | | powder |
| n) | guanidine carbonate | x) | ammonium boron-phosphate |
| | | | powder |

### Example 20

Example 17 is modified wherein another amino phosphorus containing compounds is selected from the list below and utilized in place of melamine phosphate:

a) dimelamine phosphate
b) dicyandiamide phosphate
c) urea dihydrogen phosphate
d) guanidine phosphate
e) aminoguanidine phosphate
f) diethyltriamine urea phosphate
g) melamine salt of dimethyl methyl phosphonate
h) melamine salt of dimethyl hydrogen phosphite
i) methylamine melamine phosphoric acid
j) methyl carbamate salt of phosphoric acid
k) melamine salt of boron-hydrogen phosphate
l) O-methyl urea phosphate
m) urea salt of boron-phosphate
n) urea-formaldehyde phosphate
o) aminophenol phosphate
p) ammonium urea phosphate
q) ammonium melamine phosphate
r) melamine salt of trimethyl phosphite
s) melamine salt of phenyl acid phosphate

### Example 21

Urea in the amount of 10 parts by weight is mixed with a mixture of 20 parts by weight of polyphosphorous acid and 30 parts by weight of phosphoric acid thereby producing an acidic urea phosphorus salt then an aqueous solution containing 50% potassium hydroxide is slowly added to the acidic urea phosphorus acid until the pH is 6.5.

### Example 22

20 parts by weight of urea is added to 100 parts by weight of water then 20 parts by weight of monoammonium phosphite and 20 parts by weight of diammonium phosphite are dissolve into the water. The pH is then adjusted to a pH 7 by adding ammonia hydroxide thereby producing a fertilizer, fungicide and insecticide. This mixture is diluted with water to form a 1% aqueous solution then sprayed on the leaves of plants.

### Example 23

25 parts by weight of phosphoric acid (85%) and 25 parts by weight of potassium phosphite are reacted with 10 parts by weight of urea and 5 parts by weight of methyl urea at ambient temperature and pressure then ammonia is added until a pH 5.5 is obtained thereby producing a fertilizer, fungicide and insecticide composition.

### Example 24

A dozen of similar tomato plants of about 4-5 inches tall was planted in a garden then around 4 of the plants 50 grams of the urea based composition fertilizer produced in example 13, concentrated liquid potassium urea salt of hypophosphorous and phosphoric acids, was placed around the 4 plants. 50 grams of fertilizer containing 16% nitrogen was placed around 4 other tomato plants. 4 of the plants was not fertilized. The plants were watered every other day using the same amount of water. In 10 days the tomato plants that was fertilized grew about 34 inches taller than the unfertilized plants. After 30 days the plants fertilized with the urea based composition of example 13 continued to grow at a faster rate than the other plants and were taller, had more branches and was wider than the other plants. These 4 plants also produced more tomatoes than the other plants.

### Example 25

Example 24 is modified wherein another urea based fertilizer also produced the same growth results and is used in place of the urea based composition of example 13 and selected from the list below:
1. urea based fertilizer of example 12
2. urea based fertilizer of example 14
3. urea based fertilizer of example 15
4. urea based fertilizer of example 23

### Example 26

A paper plate containing molasses which contained 10% by weight of urea based fertilizer, fungicide and pesticide composition containing melamine urea phosphate and urea borate produced in example 17 was placed near an ant hill. The ants took the composition to their ant hill and within 1 week the ant hill was abandoned.

### Example 27

A 3 inch pads covered with peanut butter diluted with peanut oil and containing 30 percent potassium urea salt of phosphorous acid produced in example 1 was placed around 10 fire ant mounds. The mound was examined 3 days later and the fire ants had left 6 of the mounds. More pads containing the peanut butter was placed around 4 mounds containing ant and with in 3 days 2 of the mounds were free of ants.

### Example 28

A lid containing corn syrup which contained 10% potassium urea salt of boron-phosphate produced in example 10 was place near an ant mound which contains sweet eating ants. The ants in the ant mound disappeared in three days.

### Example 29

The perimeter around a shed contains various plants which had a layer of pine needles and leaves around the plants, and there were a lot of cockroaches under the pine needles and the plants were losing leaves and were in poor shape. About 100 grams of potassium urea salt of boron-phosphoric acid produced in example 10 was placed around each plant. The plants were then watered every 3^{rd} day. After one week each side of the house was examined for cockroaches by checking under the pine straws. The cockroaches had disappeared from all around the plants.

After about 10 days new leaf buds began to show on the plants around the shed and within 3 week the plants had new leaves and began to grow. After 3 month the plants continue to grow and develop new leaves and branches.

### Example 30

About 1 dozen of thin wood chips were sprayed with a 20% aqueous solution of potassium urea salt of phosphorous acid produced in example 1, another dozen of wood chips were sprayed with a 20% aqueous solution of potassium urea salt of phosphoric acid, and another dozen of thin wood chips sprayed with a 20% aqueous solution potassium urea salt of phosphoric and phosphorous acid condensate containing 5% zinc borate were buried about 4 inches under the ground in a moist area near the house. These wood chips were dug up after being in the ground for 10 months. The chips still contain some the urea based fertilizer, fungicide and insecticide composition. The chips were examined for any dry rot, termite infestation and fungus and none was found.

### Example 31

Various plants were collected from a nursery which were in very poor condition and were to be destroyed. These plants were watered with a 10% solution of potassium urea salt of phosphorous acid produced in example 1 then watered every other day. The leaves were sprayed until wet with a dilute aqueous potassium urea salt of phosphorous acid (32 oz./100 gal.). Then in 10 days the plants begin to grow buds and new leaves. The plants continue to grow for 3 month without any addition of fertilizer and remained in very good condition.

### Example 32

The leaves of a peach tree contained aphides was sprayed with a 1% aqueous solution of potassium urea salt of phosphorous acid produced in example 1. The leaves were examined and found that the outer layer of the leaves had thickened and acted as a protection against aphides.

### Example 33

A board of fir lumber which had a 1″×6″ area of dryrot and had termite was sprayed with an aqueous solution containing 20% aqueous solution of potassium urea salt of boron-phosphoric acid compound produced in example 10. The lumber was placed back into the termite containing firewood then it was re-examined after 10 months the dryrot area had not gotten any larger and there is no sign of new termite damage.

### Example 34

Several fir board was sprayed with an aqueous solution containing 20% potassium urea salt of phosphoric acid and hypophosphorous acid produced in example 7 then placed in a fire wood pile which contained termites, The boards were examined after 6 months and 1 year and no termite damage or dryrot was found.

### Example 35

An 8′×8′ tool shed was infested with cockroaches. The floor around the inside walls was sprinkled with potassium urea salt of boron-phosphate powder produced in example 10. One week later all the cockroaches had disappeared, and several months later they were still gone.

### Example 36

A plant Pathologist did fungicide studies on the fungicide potassium urea salt of phosphorous acid produced in example 1. Gerber daisy infected with the pathogen Oidium sp. was placed next to uninfected plants then the plants were wet by spraying with the potassium urea salt of phosphorous acid which was diluted to 64 oz per 100 gallons of water. All treatments were applied as a foliar spray with a hand pump spray bottle and applications were made weekly for three weeks. It was concluded that it exhibited good levels of prevention of the pathogen in this test.

### Example 37

A three acre area of farm land where grass was being grown was divided into 3 areas of the same size. One area was left unfertilized, one area was fertilized with sprayed aqueous urea and the other area was fertilized with aqueous potassium urea salt of phosphorous acid produced in example 1. The same of amount of nitrogen was sprayed on the two areas. The same amount of water was applied to each area. For the first month the two fertilized areas grass grew faster and was greener than the unfertilized area's grass. After 1 month the unfertilized and the area's grass ferterilized with the urea was growing very little and was turning brown-green in color. The area fertilized with the aqueous potassium urea salt of phosphorous acid continued to grow more than the other two areas and remained bright green in color for another 2 months.

### Example 38

Two rows of corn about 400 feet long was fertilized, one rows with aqueous urea and one row with the potassium urea salt of phosphorous acid produced in example 1. The same amount of nitrogen was plowed into each row. The rows was watered by a limited amount of rain. The corn on the rows was harvested and compared. The yield on the two rows that was fertilized with the potassium urea salt of phosphorous acid had a 25% better yield of corn and the corn kernels on these corn cobs produced about 20% more kernals the corn fertilized by urea. The corn produced in the rows fertilized with the aqueous potassium urea salt of phosphorous acid had much less damage to the kernels and much less damage to the corn silk by insects and fungus.

### CONCLUSION

It is surprising that the urea based salt compounds has very good insecticide, fungicide and fertilizing properties and had long lasting nitrogen. The addition of salt forming compounds such as phosphoric acid and potassium phosphate increase the fertilizing immediate and prolonged effect and forms fungus and aphides protection. The addition of salt forming compounds such as phosphoric acid, boric acid and borates increase its effectiveness against insect such as ants, termites and cockroaches and against fungus.

It will be appreciated by those skilled in the Arts that changes and modifications of the preferred embodiment can be made without departing from the spirit and broader aspects of the invention as set forth in the appended claims.

1. An insecticide, fungicide and fertilizer composition produced by the process comprising of mixing, heating and reacting the following components:
(A) urea and/or methyl urea, 25-100 parts by weight;
(B) acidic salt forming compounds, 25 to 400 parts by weight and selected from the group consisting of phosphorus oxyacid, acidic salts of phosphorus oxyacids, organic phosphorus compounds, boron-phosphorus, boron oxyacid, acidic boron salts, acidic sulfur compounds and mixture thereof;
(C) basic salt forming compound, 25 to 300 parts by weight;
then add and mix;
(D) filler, 0 to 300 parts by weight;
(E) water, 0 to a sufficient amount for dilution;
components A and B are first mixed, then heated up to 120 degree C. at ambient pressure for 0.1 to 3 hours and reacted to produce a urea salt of an acidic compound, then component C is added, mixed, heated to 100 to 120 degrees C. at ambient pressure for 0.1 to 3 hours and reacted, thereby producing a compound consisting of a basic compound and urea salt of an acidic compound, then component D is added and mixed thereby producing a urea composition, then 0 to a sufficient amount water to form a dilute aqueous solution is added.

2. The insecticide, fungicide and fertilizer composition of claim 1 wherein the acidic salt forming compound is phosphorus compounds that will react with urea and mixtures thereof in an amount of 25 to 400 parts by weight.

3. The insecticide, fungicide and fertilizer composition of claim 1 wherein the basic salt forming compound is selected from the group consisting of alkali metal compounds, alkaline earth metal compounds, ammonia, amines, polyamines, metal compounds and mixtures thereof.

4. The fertilizer, insecticide and fungicide composition of claim 1 wherein the filler is selected from the group consisting of urea, melamine, dicyandiamide, melamine cyanurate, amino phosphates, aminopolyphosphates, aminoplasts, phenoplasts, powdered synthetic resins, sawdust, carbohydrates, ammonium sulfate, ammonium phosphate, amino phosphates, potassium phosphate, amino sulfates, silica, diatomaceous earth, alkali metal silicates, alkaline earth metal silicates, metals, metal silicates, oxides, carbonates, sulphates, phosphates and borates, potassium hydrogen phosphate and mixtures thereof, in an amount 0 to 300 parts by weight.

5. The insecticide, fungicide and fertilizer composition of claim 1 wherein the basic compound urea salt of an acidic compound is an potassium urea salt of phosphorus oxyacid.

6. The insecticide, fungicide and fertilizer composition of claim 1 wherein the basic compound urea salt of an acidic compound is potassium urea salt of organic phosphorus compound.

7. The insecticide, fungicide and fertilizer composition of claim 1 wherein the acidic salt forming phosphorus containing compound is a phosphorus compound selected from the group consisting of phosphorus oxyacids with valence of 5, phosphorus oxyacids with a valence of 34, acidic salts of phosphorus oxyacids, phosphonates, phosphiltes, organic phosphates and mixtures thereof.

8. The insecticide, fungicide and fertilizer composition of claim 1 wherein the acidic salt forming phosphorus containing compound is a phosphite.

9. The insecticide, fungicide and fertilizer composition of claim 1 wherein the basic compound urea salt of an acidic compound is potassium urea salt of phosphorous acid and phosphoric acid.

10. The insecticide, fungicide and fertilizer composition of claim 9 wherein the organic phosphorus compound is organic phosphorus compound which has a valence of 34.

11. The insecticide, fungicide and fertilizer composition of claim 1 wherein the acidic salt forming compound is a mixture of phosphorous and phosphoric acid.

12. The insecticide, fungicide and fertilizer composition of claim 1 wherein the salt forming compounds are phosphorous acid and potassium hydroxide.

13. A method for producing insecticide, fungicide and fertilizer composition comprising of mixing, heating and reacting the following components;
(A) urea and/or methyl urea, in the amount of 25-100 parts by weight;
(B) acidic salt forming compound, in the amount of 25 to 400 parts by weight;
(C) basic salt forming compound, in the amount of 25 to 300 parts by weight;
then add and mix;
(D) filler, in the amount of 0 to 300 parts by weight;
(E) water, in the amount of 0 to sufficient water for diluted aqueous solutions;
components A and B are first mixed then heated to up to 120 degrees C. at ambient pressure for 0.1 to 3 hours thereby producing a urea salt of an acidic compound, then component C is added, mixed, heated at 100 to 120 degree C. at ambient pressure for 0.1 To 3 hours thereby producing a basic compound urea salt of an acidic compound then component D and E are added and mixed thereby producing a basic compound urea salt of an acidic compound composition.

14. The method of claim 13 wherein the basic compound urea salt of an acidic compound is potassium urea salt of phosphorous acid.

15. The product produced by the method of claim 13-14.

16. A fertilizer, fungicide and insecticide composition produced by the process consisting of mixing, heating and reacting urea with an acidic phosphorus compound consisting of phosphorous acid, hyphophosphoric acid, polyphosphorous acid, polyhypophosphorous acid and their salts, phosphoric acid, organic phosphorus compounds with a valence of 3-4 and mixtures thereof then add and react potassium hydroxide and/or ammonia with the acidic urea salt of phosphorus containing compound until the pH is 5 to 8.5, then add and mix 0-300 parts by weight of a filler and 0 to sufficient amount of water to dilute the fertilizer, fungicide and insecticide composition.

17. The fertilizer, fungicide and insecticide composition of claim 16 wherein the urea is reacted with phosphorous acid then reacted with potassium hydroxide until the pH is 6-8.

18. The fertilizer, fungicide and insecticide composition of claim 16 wherein the urea is reacted with a mixture of organic phosphite and phosphoric acid then reacted with ammonia until the pH is 5-8.

19. The fertilizer, fungicide and insecticide composition of claim 16 wherein a filler, tetrapotassium pyrophosphate is added to the potassium or ammonia urea salt of phosphorus containing compound.

20. The method of claim 13 wherein the acidic salt forming compound is selected from the group consisting of phosphorus oxyacids, boron oxyacids, sulfur oxyacids, boron-phosphates, phosphates, phosphorous acid, hypophosphorous acid, polyphosphorous acid, polyhypophosphorus acid, ammonium salts of phosphorous acids, polyphosphates of ammonia, alkali metal hydrogen phosphates, alkaline earth metal hydrogen phosphates, Acidic phosphates of amines, polyamines, amino compounds, thioureas, alkyanolamines, boric acid and its salts and their derivatives, organic phosphorus compounds and their salts, halogenated organic phosphorus compounds, their salts and their derivatives, organic acids, nitrogen containing salts of boron-phosphate oxyacid, phosphoric acid, pyrophosphoric acid, triphosphoric acid, metaphosphoric acid, phosphorous acid, hydrophosphorous acid, phosphinic acid, phosphinous acid, phosphine oxide, phosphorus trihalides, phosphorus oxyhalides, phosphorus oxide, mono-metal hydrogen phosphates, ammonia dihydrogen phosphate, bromated phosphates, alkali metal dihydrogen phosphate and halogenated phosphate-phosphite and their halides and acids, alkylchlorophosphines, alkyl phosphines, alkyl phosphites, dialkyl hydrogen phosphites, dialkyl alkyl phosphonates, trialkyl phosphites, organic acid phosphates, organic diphosphonate esters, aryl phosphites, aryl hydrogen phosphates, halogenated phosphonates esters and mixtures thereof.
